(19) United States
(12) Patent Application Publication
(10) Pub. No.: US 2023/0238515 A1
(43) Pub. Date: Jul. 27, 2023

(54) POSITIVE ELECTRODE

(71) Applicants: TOYOTA JIDOSHA KABUSHIKI KAISHA, Toyota-shi (JP); Panasonic Holdings Corporation, Osaka (JP)

(72) Inventors: Ryuto SAKAMOTO, Okazaki-shi (JP); Kenji NAGAO, Toyota-shi (JP); Izuru SASAKI, Kyoto-shi (JP); Yusuke NISHIO, Osaka (JP); Hiroki KAMITAKE, Osaka (JP)

(73) Assignees: TOYOTA JIDOSHA KABUSHIKI KAISHA, Toyota-shi (JP); Panasonic Holdings Corporation, Osaka (JP)

(21) Appl. No.: 18/078,222

(22) Filed: Dec. 9, 2022

(30) Foreign Application Priority Data
Jan. 27, 2022 (JP) 2022-010733

(51) Int. Cl. H01M 4/36; H01M 4/131; H01M 4/46; H01M 4/62

(52) U.S. Cl. CPC H01M 4/366; H01M 4/131; H01M 4/463; H01M 4/621; H01M 2004/028

(57) ABSTRACT

A positive electrode includes a positive electrode current collector, an adhesive layer, and a positive electrode layer. The positive electrode current collector, the adhesive layer, and the positive electrode layer are stacked in this order. The adhesive layer contains spherical carbon and fibrous carbon as an electrically conductive material, and contains an acrylic binder as an adhesive.

### CROSS-REFERENCE TO RELATED APPLICATION

This application claims priority to Japanese Patent Application No. 2022-010733 filed on Jan. 27, 2022, incorporated herein by reference in its entirety.

### BACKGROUND

### 1. Technical Field

The present disclosure relates to positive electrodes.

### 2. Description of Related Art

With the recent rapid spread of information-related equipment and communication equipment such as personal computers, video cameras, and mobile phones, development of batteries used as power sources for such equipment has become critical. High-output, high-capacity batteries for battery electric vehicles or hybrid electric vehicles have also been increasingly developed in the automobile industry etc.

Japanese Unexamined Patent Application Publication No. 2019-021635 (JP 2019-021635 A) discloses current collector foil for an electrode. The current collector foil includes an adhesive layer. The adhesive layer contains electrically conductive particles and a binder. The electrically conductive particle includes a base material particle, a first electrically conductive layer located on the surface of the base material particle and made of silver or copper, and a second electrically conductive layer located on the outer surface of the first electrically conductive layer and made of nickel.

Japanese Unexamined Patent Application Publication No. 2010-238575 (JP 2010-238575 A) discloses an electrode containing an electrically conductive material that is a combination of fine fibrous carbon with a diameter of less than 100 nm and fibrous carbon with a diameter of 100 nm or more.

Japanese Unexamined Patent Application Publication No. 2016-058277 (JP 2016-058277 A) discloses a positive electrode mixture containing an electrically conductive material that is a combination of carbon fiber and particulate carbon.

### SUMMARY

There is a demand for batteries with lower resistance and higher durability. For example, the use of carbon-coated foil as a positive electrode current collector may result in an excessive amount of electrically conductive material added to a positive electrode layer. This reduces the contact resistance (foil contact resistance) between the positive electrode layer and the positive electrode current collector (positive electrode current collector foil), but may reduce the durability of the battery. Increasing the proportion of the electrically conductive material in the positive electrode layer can reduce the foil contact resistance. However, since a part of a plurality of ion conduction paths in the positive electrode layer is blocked, the internal resistance of the battery may increase. In addition, a side reaction between a solid electrolyte and the electrically conductive material may accelerate reduction in durability of the battery.

The present disclosure provides a positive electrode that can implement a battery with lower resistance and higher durability.

The positive electrode of the present disclosure includes a positive electrode current collector, an adhesive layer, and a positive electrode layer. The positive electrode current collector, the adhesive layer, and the positive electrode layer are stacked in this order. The adhesive layer contains spherical carbon and fibrous carbon as an electrically conductive material, and contains an acrylic binder as an adhesive.

In the positive electrode of the present disclosure, the positive electrode layer may contain a positive electrode active material. The positive electrode active material may be a lithium-transition metal composite oxide represented by LiNiₓM₁₋ₓO₂. In the lithium-transition metal composite oxide, x may satisfy 0.5≤x<1, and M may represent at least one element selected from the group consisting of cobalt (Co), manganese (Mn), and aluminum (Al).

In the positive electrode of the present disclosure, the positive electrode layer may contain the spherical carbon and the fibrous carbon as the electrically conductive material. A volume fraction of the electrically conductive material in the positive electrode layer may be 3 volume % to 6 volume % when a total volume of the positive electrode layer is taken as 100 volume %.

In the positive electrode of the present disclosure, a mass fraction of the spherical carbon may be 7 mass % to 12 mass % when a total mass of the spherical carbon and the fibrous carbon in the positive electrode layer is taken as 100 mass %.

In the positive electrode of the present disclosure, the spherical carbon may be acetylene black.

In the positive electrode of the present disclosure, a volume fraction of the acrylic binder in the adhesive layer may be 50 volume % to 80 volume % when a total volume of the adhesive layer is taken as 100 volume %.

The present disclosure provides a positive electrode that can implement a battery with lower resistance and higher durability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing an example of a positive electrode of the present disclosure.

### DETAILED DESCRIPTION OF EMBODIMENTS

Hereinafter, an embodiment according to the present disclosure will be described. It should be noted that matters other than those specifically mentioned in the present specification and necessary to carry out the present disclosure (e.g., a general configuration and manufacturing process of a positive electrode that do not characterize the present disclosure) may be grasped based on the related art. The present disclosure may be carried out based on the content disclosed in the present specification and the common general technical knowledge in the art. The dimensional relationships (such as length, width, and thickness) in the drawings do not reflect the actual dimensional relationships. In the present specification, a hyphen “-” or word “to” indicating a numerical range is used to mean an inclusive range in which the numerical values before and after “-” or “to” are included as its lower and upper limit values. Any combination of values can be used as upper and lower limit values of a numerical range.

A positive electrode of the present disclosure includes a positive electrode current collector, an adhesive layer, and a positive electrode layer. The positive electrode current collector, the adhesive layer, and the positive electrode layer are stacked in this order. The adhesive layer contains spherical carbon and fibrous carbon as an electrically conductive material, and contains an acrylic binder as an adhesive.

Contact resistance (foil contact resistance) between the positive electrode layer and the positive electrode current collector (positive electrode current collector foil) can be significantly reduced by using the adhesive layer containing an acrylic binder and a carbon conductive material to bond the positive electrode layer and the positive electrode current collector together. This eliminates the need to add an excessive amount of electrically conductive material to the positive electrode layer, and thus reduces the amount of electrically conductive material in the positive electrode layer. As a result, a battery with lower resistance and higher durability can be implemented.

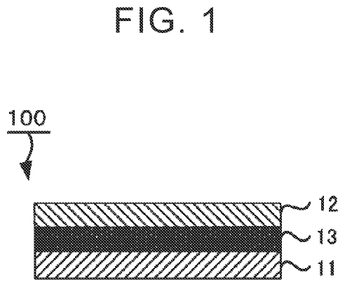

FIG. 1 is a schematic sectional view showing an example of the positive electrode of the present disclosure. As shown in FIG. 1, a positive electrode 100 of the present disclosure includes a positive electrode current collector 11 and a positive electrode layer 12, and the positive electrode current collector 11 and the positive electrode layer 12 are bonded together by an adhesive layer 13.

Positive Electrode

A positive electrode of the present disclosure includes a positive electrode current collector, an adhesive layer, and a positive electrode layer. The positive electrode current collector, the adhesive layer, and the positive electrode layer are stacked in this order. The positive electrode current collector and the positive electrode layer may be bonded together by the adhesive layer.

Adhesive Layer

The adhesive layer contains spherical carbon and fibrous carbon as an electrically conductive material, and contains an acrylic binder as an adhesive. The electrically conductive material may be a composite of spherical carbon and fibrous carbon. An example of the spherical carbon is carbon black. Examples of carbon black include acetylene black and Ketjen black. The spherical carbon may be acetylene black. When the spherical carbon contains acetylene black, the electron conductivity in the positive electrode can further be improved. Examples of the fibrous carbon material include fibrous carbon such as vapor-grown carbon fibers, carbon nanotubes, and carbon nanofibers. The volume fraction of the electrically conductive material in the adhesive layer may be 20 volume % to 50 volume % when the total volume of the adhesive layer is taken as 100 volume %.

The adhesive is not particularly limited as long as it is an acrylic binder. Examples of the acrylic binder include polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, and acrylonitrile butadiene rubber (NBR). Since the elastic modulus of the acrylic binder changes greatly with temperature, the acrylic binder can easily bond the positive electrode current collector and the positive electrode layer together. The volume fraction of the acrylic binder in the adhesive layer may be 50 volume % to 80 volume % when the total volume of the adhesive layer is taken as 100 volume %. The thickness of the adhesive layer is not particularly limited, but may be 0.5 μm to 5 μm.

Positive Electrode Layer

The positive electrode layer contains a positive electrode active material, and may contain an electrically conductive material, a solid electrolyte, a binder, etc. as optional components.

There is no particular limitation on the type of positive electrode active material, and any material that can be used as an active material for batteries can be used as a positive electrode active material. Examples of the positive electrode active material include a lithium alloy, LiCoO₂, LiNiₓMiₓO₂ (x satisfies 0.5≤x<1, and M represents at least one element selected from the group consisting of Co, Mn, and Al), LiMnO₂, a heteroelement-substituted Li—Mn spinel, a lithium titanate, a lithium metal phosphate, LiCoN, Li₂SiO₃, Li₄SiO₄, a transition metal oxide, TiS₂, Si, SiO₂, a silicon (Si) alloy, and a lithium-storable intermetallic compound. Examples of the heteroelement-substituted Li—Mn spinel include LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄. An example of the lithium titanate is Li₄Ti₅O₁₂. Examples of the lithium metal phosphate include LiFePO₄, LiMnPO₄, LiCoPO₄, and LiNiPO₄. Examples of the transition metal oxide include V₂O₅ and MoO₃. Examples of the lithium-storable intermetallic compound include Mg₂Sn, Mg₂Ge, Mg₂Sb, and Cu₃Sb. Examples of the lithium alloy include Li—Au, Li—Mg, Li—Sn, Li—Si, Li—Al, Li—B, Li—C, Li—Ca, Li—Ga, Li—Ge, Li—As, Li—Se, Li—Ru, Li—Rh, Li—Pd, Li—Ag, Li—Cd, Li—In, Li—Sb, Li—Ir, Li—Pt, Li—Hg, Li—Pb, Li—Bi, Li—Zn, Li—Tl, Li—Te, and Li—At. Examples of the Si alloy include alloys of Si and a metal such as Li. The Si alloy may be an alloy of Si and at least one metal selected from the group consisting of tin (Sn), germanium (Ge), and aluminum (Al). The positive electrode active material may be a lithium-transition metal composite oxide represented by LiNiₓMiₓO₂ among others. Examples of the lithium-transition metal composite oxide include a lithium nickel cobalt aluminate (LiNi_{1-x-y}CoₓAl_{y}O₂, x=0.05 to 0.2, y=0.05 to 0.2, NCA) and a lithium nickel cobalt manganese oxide (LiNiₓCo_{y}Mn_{1-x-y}O₂, x=0.5 to 0.8, y=0.1 to 0.2, NCM). Examples of NCM include NCM-523, NCM-622, and NCM-811. The form of the positive electrode active material is not particularly limited, but the positive electrode active material may be in the form of particles. When the positive electrode active material is in the form of particles, the positive electrode active material may be in the form of primary particles or secondary particles. A coating layer containing an Li-ion conductive oxide may be formed on a surface of the positive electrode active material. This is because the coating layer can reduce the reaction between the positive electrode active material and the solid electrolyte. Examples of the Li-ion conductive oxide include LiNbO₃, Li₄Ti₅O₁₂, and Li₃PO₄. The thickness of the coating layer is, for example, 0.1 nm or more, and may be 1 nm or more. The thickness of the coating layer is, for example, 100 nm or less, and may be 20 nm or less. The coating layer may cover, for example, 70% or more of the surface of the positive electrode active material, or may cover 90% or more of the surface of the positive electrode active material.

From the standpoint of improving the electron conductivity of the positive electrode layer, the electrically conductive material may be, for example, spherical carbon and fibrous carbon mentioned above as examples of the electrically conductive material contained in the adhesive layer, or may be, for example, a mixture or composite thereof. Various other materials can be used as the electrically conductive material. For example, the electrically conductive material may be metal particles. Examples of the metal particles include particles of nickel (Ni), copper (Cu), iron (Fe), and SUS. When the total volume of the positive electrode layer is taken as 100 volume %, the volume fraction of the electrically conductive material in the positive electrode layer may be 3 volume % or more and 6 volume % or less, may be 3.51 volume % or more, may be 5.59 volume % or less, or may be 4.72 volume % or less. When the total mass of the spherical carbon and fibrous carbon in the positive electrode layer is taken as 100 mass %, the mass fraction of the spherical carbon may be 7 mass % or more and 12 mass % or less, may be 8.3 mass % or more, or may be 11.4 mass % or less. When the total mass of the positive electrode active material in the positive electrode layer is taken as 100 mass %, the mass fraction of the spherical carbon relative to the positive electrode active material may be 0.3 mass %. When the total mass of the positive electrode active material in the positive electrode layer is taken as 100 mass %, the mass fraction of the fibrous carbon relative to the positive electrode active material may be 2.34 mass % or more and 4 mass % or less, or may be 3.30 mass % or less.

Examples of the solid electrolyte are similar to examples of a solid electrolyte that will be mentioned later for a solid electrolyte layer. The content of the solid electrolyte in the positive electrode layer is not particularly limited, but may be in the range of, for example, 1 mass % to 80 mass % when the total mass of the positive electrode layer is taken as 100 mass %.

Examples of the binding agent (binder) include polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, acrylonitrile-butadiene rubber (NBR), butadiene rubber (BR), polyvinylidene fluoride (PVDF), and styrene-butadiene rubber (SBR). Among others, the binding agent (binder) may be styrene-butadiene rubber (SBR), polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, acrylonitrile-butadiene rubber (NBR), etc. The content of the binder in the positive electrode layer is not particularly limited.

The thickness of the positive electrode layer is not particularly limited, but may be, for example, 10 μm to 100 μm.

The positive electrode layer can be formed by various methods. For example, the positive electrode layer can be formed by adding a positive electrode active material and, as necessary, other component(s) to a solvent and stirring the resultant mixture to produce a positive electrode layer forming paste, and applying the positive electrode layer forming paste to one surface of a support and drying the positive electrode layer forming paste. Examples of the solvent include butyl acetate, butyl butyrate, mesitylene, tetralin, heptane, and N-methyl-2-pyrrolidone (NMP). A method for applying a positive electrode layer forming paste to one surface of a support is not particularly limited, and examples of this method include a doctor blade method, a metal mask printing method, an electrostatic coating method, a dip coating method, a spray coating method, a roll coating method, a gravure coating method, and a screen printing method. A material having self-supporting properties can be selected as appropriate and used as a support. The support is not particularly limited, and can be, for example, metal foil such as Cu or Al.

Another method for forming a positive electrode layer is a method in which a positive electrode layer is formed by pressure-forming a powder of a positive electrode mixture containing a positive electrode active material and, as necessary, other component(s). When pressure-forming a powder of a positive electrode mixture, a press pressure that is usually applied to the powder is a surface pressure of 1 MPa or more and 2000 MPa or less, and is a linear pressure of 1 ton/cm or more and 100 ton/cm or less. The pressing method is not particularly limited, but is, for example, a method in which a pressure is applied using a flat plate press, a roll press, etc.

Positive Electrode Current Collector

Various metals that can be used as current collectors for batteries can be used as the positive electrode current collector. Examples of such metals include metal materials containing one or more elements selected from the group consisting of copper (Cu), nickel (Ni), aluminum (Al), vanadium (V), gold (Au), platinum (Pt), magnesium (Mg), iron (Fe), titanium (Ti), cobalt (Co), chromium (Cr), zinc (Zn), germanium (Ge), and indium (In). Examples of the positive electrode current collector include SUS, aluminum, nickel, iron, titanium, and carbon. The form of the positive electrode current collector is not particularly limited, and the positive electrode current collector may be in various forms such as foil and mesh. The thickness of the positive electrode current collector varies depending on the shape of the positive electrode current collector, but may be, for example, in the range of 1 μm to 50 μm or in the range of 5 μm to 20 μm.

Battery

The positive electrode of the present disclosure can be used as a positive electrode for various batteries.

A battery of the present disclosure may include a positive electrode, an electrolyte layer, and a negative electrode.

Negative Electrode

The negative electrode includes a negative electrode layer and a negative electrode current collector.

Negative Electrode Layer

The negative electrode layer contains at least a negative electrode active material, and as necessary, a solid electrolyte, an electrically conductive material, a binding agent, etc. Examples of the negative electrode active material include graphite, mesocarbon microbeads (MCMBs), highly oriented pyrolytic graphite (HOPG), hard carbon, soft carbon, elemental lithium, a lithium alloy, elemental Si, an Si alloy, and Li₄Ti₅O₁₂. Examples of the lithium alloy and the Si alloy are similar to the examples of the lithium alloy and the Si alloy mentioned above for the positive electrode active material. The form of the negative electrode active material is not particularly limited, and the negative electrode active material may be in the form of particles or a plate. When the negative electrode active material is in the form of particles, the negative electrode active material may be in the form of primary particles or secondary particles. Examples of the electrically conductive material and the binding agent that are used for the negative electrode layer are similar to the examples of the electrically conductive material and the binding agent mentioned above for the positive electrode layer. Examples of the solid electrolyte that is used for the negative electrode layer are similar to the examples of the solid electrolyte that will be mentioned later for the solid electrolyte layer. The thickness of the negative electrode layer is not particularly limited, but may be, for example, 10 μm to 100 μm. The content of the negative electrode active material in the negative electrode layer is not particularly limited, but may be, for example, 20 mass % to 90 mass %. An example of a method for forming a negative electrode layer is a method in which a negative electrode layer forming paste containing a negative electrode active material is applied to a support and dried. Examples of the support are similar to the examples of the support mentioned above for the positive electrode layer.

Negative Electrode Current Collector

The material of the negative electrode current collector may be a material that does not alloy with Li, and is, for example, SUS, copper, or nickel. The negative electrode current collector is in the form of, for example, foil or a plate. The shape of the negative electrode current collector as viewed in plan is not particularly limited, but is, for example, a circle, an ellipse, a rectangle, or any desired polygon. The thickness of the negative electrode current collector varies depending on the shape of the negative electrode current collector, but may be, for example, in the range of 1 μm to 50 μm or in the range of 5 μm to 20 μm.

Electrolyte Layer

The electrolyte layer contains at least an electrolyte. The electrolyte can be an aqueous electrolyte solution, a non-aqueous electrolyte solution, a gel electrolyte, a solid electrolyte, etc. One of these electrolytes may be used alone, or two or more of these electrolytes may be used in combination.

The solvent of the aqueous electrolyte solution contains water as a main component. That is, the content of water may be 50 mol % or more, particularly 70 mol % or more, more particularly 90 mol % or more, based on the total amount of the solvent (liquid component) (100 mol %) of the electrolyte solution. The upper limit of the content of water in the solvent is not particularly limited.

The solvent contains water as a main component. However, the solvent may contain a solvent other than water. The solvent other than water is, for example, one or more selected from ethers, carbonates, nitriles, alcohols, ketones, amines, amides, sulfur compounds, and hydrocarbons. The content of the solvent other than water may be 50 mol % or less, particularly 30 mol % or less, more particularly 10 mol % or less, based on the total amount of the solvent (liquid component) (100 mol %) of the electrolyte solution.

The aqueous electrolyte solution used in the present disclosure contains an electrolyte. Various electrolytes can be used as the electrolyte for the aqueous electrolyte solution. Examples of the electrolyte include lithium salts, nitrates, acetates, and sulfates of imidic acid compounds. Specific examples of the electrolyte include lithium bis(fluorosulfonyl)imide (LiFSI; CAS No. 171611-11-3), lithium bis(trifluoromethanesulfonyl)imide (LiTFSI; CAS No. 90076-65-6), lithium bis(pentafluoroethanesulfonyl)imide (LiBETI; CAS No. 132843-44-8), lithium bis(nonafluorobutanesulfonyl)imide (CAS No. 119229-99-1), lithium nonafluoro-N-[(trifluoromethane)sulfonyl]butanesulfonylamide (CAS No. 176719-70-3), lithium N,N-hexafluoro-1,3-disulfonylimide (CAS No. 189217-62-7), CH₃COOLi, LiPF₆, LiBF₄, Li₂SO₄, and LiNO₃.

The concentration of the electrolyte in the aqueous electrolyte solution can be set as appropriate within a range that does not exceed the saturation concentration of the electrolyte in the solvent, according to desired battery characteristics. This is because, if a solid electrolyte remains in an aqueous electrolyte solution, the solid may inhibit battery reactions. For example, when the electrolyte is LiTFSI, the aqueous electrolyte solution may contain 1 mol or more, particularly 5 mol or more, more particularly 7.5 mol or more of LiTFSI per kilogram of water. The upper limit of the concentration of the electrolyte is not particularly limited, and may be, for example, 25 mol or less per kilogram of water.

An electrolyte solution containing a lithium salt and a non-aqueous solvent is usually used as a non-aqueous electrolyte solution. Examples of the lithium salt include: inorganic lithium salts such as LiPF₆, LiBF₄, LiClO₄, and LiAsF₆; and organic lithium salts such as LiCF₃SO₃, LiN(SO₂CF₃)₂(Li-TFSI), LiN(SO₂C₂F₅)₂, and LiC(SO₂CF₃)₃. Examples of the non-aqueous solvent include ethylene carbonate (EC), propylene carbonate (PC), butylene carbonate (BC), dimethyl carbonate (DMC), diethyl carbonate (DEC), ethyl methyl carbonate (EMC), γ-butyrolactone, sulfolane, acetonitrile (ACN), dimethoxymethane, 1,2-dimethoxyethane (DME), 1,3-dimethoxypropane, diethyl ether, tetraethylene glycol dimethyl ether (TEGDME), tetrahydrofuran, 2-methyl tetrahydrofuran, dimethyl sulfoxide (DMSO), and mixtures thereof. From the standpoint of ensuring a high dielectric constant and low viscosity, the non-aqueous solvent may be a mixture of a cyclic carbonate compound having a high dielectric constant and high viscosity such as EC, PC, or BC and a chain carbonate compound having a low dielectric constant and low viscosity such as DMC, DEC, or EMC, or may be a mixture of EC and DEC. The concentration of the lithium salt in the non-aqueous electrolyte solution may be, for example, 0.3 M to 5 M.

The gel electrolyte is usually an electrolyte obtained by adding a polymer to a non-aqueous electrolyte solution for gelation. Specifically, the gel electrolyte is obtained by adding a polymer such as polyethylene oxide, polypropylene oxide, polyacrylonitrile, polyvinylidene fluoride (PVDF), polyurethane, polyacrylate, or cellulose to the above non-aqueous electrolyte solution for gelation.

A separator that is impregnated with an electrolyte such as the above aqueous electrolyte solution and that prevents the positive electrode layer and the negative electrode layer from contacting each other may be used in the electrolyte layer. The material of the separator is not particularly limited as long as it is a porous film. Examples of the material of the separator include resins such as polyethylene (PE), polypropylene (PP), polyester, cellulose, and polyamide. Among all, the material of the separator may be polyethylene and polypropylene. The separator may have a single-layer structure or a multi-layer structure. Examples of the separator having a multi-layer structure include a separator having a two-layer structure of PE/PP, and a separator having a three-layer structure of PP/PE/PP or PE/PP/PE. The separator may be a non-woven fabric such as resin non-woven fabric or glass fiber non-woven fabric.

Solid Electrolyte Layer

The electrolyte layer may be a solid electrolyte layer composed of a solid. The solid electrolyte layer contains at least a solid electrolyte. Various solid electrolytes that can be used in all-solid-state batteries can be used as appropriate as the solid electrolyte contained in the solid electrolyte layer. Examples of such a solid electrolyte include inorganic solid electrolytes such as sulfide solid electrolyte, oxide solid electrolyte, hydride solid electrolyte, halide solid electrolyte, and nitride solid electrolyte. The sulfide solid electrolyte may contain sulfur (S) as a main component of an anionic element. The oxide solid electrolyte may contain oxygen (O) as a main component of an anionic element. The hydride solid electrolyte may contain hydrogen (H) as a main component of an anionic element. The halide solid electrolyte may contain halogen (X) as a main component of an anionic element. The nitride solid electrolyte may contain nitrogen (N) as a main component of an anionic element.

The sulfide solid electrolyte may be sulfide glass, crystallized sulfide glass (glass-ceramic), or a crystalline material that is obtained by performing a solid-phase reaction process on a raw material composition. The crystalline state of the sulfide solid electrolyte can be checked by, for example, performing powder X-ray diffraction measurement of the sulfide solid electrolyte using Cu K-α radiation.

Sulfide glass can be obtained by amorphizing a raw material composition (e.g., a mixture of Li₂S and P₂S₅). An example of the amorphization process is mechanical milling.

A glass-ceramic can be obtained by, for example, heat-treating sulfide glass. The heat treatment temperature need only be higher than the crystallization temperature (Tc) observed by thermal analysis measurement of sulfide glass, and is usually 195° C. or higher. The upper limit of the heat treatment temperature is not particularly limited. The crystallization temperature (Tc) of sulfide glass can be measured by differential thermal analysis (DTA). The heat treatment time is not particularly limited as long as desired crystallinity of the glass-ceramic can be obtained. For example, the heat treatment time is in the range of one minute to 24 hours, and particularly in the range of one minute to 10 hours. The heat treatment method is not particularly limited, but is, for example, a method using a firing furnace.

An example of the oxide solid electrolyte is a solid electrolyte containing Li element, Y element (Y is at least one of the following elements: niobium (Nb), boron (B), aluminum (Al), silicon (Si), phosphorus (P), titanium (Ti), zirconium (Zr), molybdenum (Mo), tungsten (W), and sulfur (S)), and oxygen (O) element. Specific examples of the oxide solid electrolyte include: garnet solid electrolytes such as Li₇La₃Zr₂O₁₂, Li₇₋ₓLa₃(Zr₂₋ₓNbₓ)O₁₂ (0≤x≤2), and Li₅La₃Nb₂O₁₂; perovskite solid electrolytes such as (Li, La)TiO₃, (Li, La)NbO₃, and (Li, Sr)(Ta, Zr)O₃; NASICON solid electrolytes such as Li(Al, Ti)(PO₄)₃ and Li(Al, Ga)(PO₄)₃; Li—P—O solid electrolytes such as Li₃PO₄ and LIPON (compound Li₃PO₄ with a part of O substituted with nitrogen (N)); and Li—B—O solid electrolytes such as Li₃BO₃ and compound Li₃BO₃ with a part of O substituted with carbon (C). In the present disclosure, the notation “(A, B, C)” in chemical formulas means “at least one selected from the group consisting of A, B, and C.”

The hydride solid electrolyte contains, for example, Li and a complex anion containing hydrogen. Examples of the complex anion include (BH₄)⁻, (NH₂)⁻, (AlH₄)⁻, and (AlH₆)³⁻.

The halide solid electrolyte is represented by, for example, the following compositional formula (1).

Li_{α}M_{β}X_{γ} (1)

In composition formula (1), α, β, and γ are independent of each other, and each of α, β, and γ have a value larger than zero. M includes at least one element selected from the group consisting of metal elements other than Li and metalloid elements. X includes at least one selected from the group consisting of fluorine (F), chlorine (Cl), bromine (Br), and iodine (I). In the present disclosure, the “metalloid elements” refer to boron (B), silicon (Si), germanium (Ge), arsenic (As), antimony (Sb), and tellurium (Te). The “metal elements” refer to all the elements in Groups 1 to 12 of the periodic table except hydrogen and all the elements in Groups 13 to 16 of the periodic table except boron (B), silicon (Si), germanium (Ge), arsenic (As), antimony (Sb), tellurium (Te), carbon (C), nitrogen (N), phosphorus (P), oxygen (O), sulfur (S), and selenium (Se). That is, the “metalloid elements” or “metal elements” refer to a group of elements that can become cations when they form an inorganic compound with halogen element.
More specific examples of the halide solid electrolyte include Li₃YX₆, Li₂MgX₄, Li₂FeX₄, LiAlX₄, LiGaX₄, LiInX₄, Li₃AlX₆, Li₃GaX₆, and Li₃InX₆. X represents at least one selected from the group consisting of F, Cl, Br, and I.

An example of the nitride solid electrolyte is Li₃N.

The solid electrolyte may be in the form of particles from the standpoint of ease of handling. The average particle size of the particles of the solid electrolyte is not particularly limited, but is, for example, 10 nm or more, and may be 100 nm or more. The average particle size of the particles of the solid electrolyte is, for example, 25 μm or less, and may be 10 μm or less.

In the present disclosure, the average particle size of particles is a value of a volume-based median diameter (D50) measured by laser diffraction/scattering particle size distribution measurement, unless otherwise specified. In the present disclosure, the median diameter (D50) refers to the diameter (volume mean diameter) that splits the cumulative volume size distribution of particles with half above and half below this diameter (50%).

One solid electrolyte may be used alone, or two or more solid electrolytes may be used in combination. When two or more solid electrolytes are used, the two or more solid electrolytes may be mixed, or a multi-layer structure composed of two or more layers of the individual solid electrolytes may be formed. The proportion of the solid electrolyte in the solid electrolyte layer is not particularly limited, but is, for example, 50 mass % or more, and may be 60 mass % or more and 100 mass % or less, may be 70 mass % or more and 100 mass %, or may be 100 mass %.

The solid electrolyte layer may contain a binding agent from the standpoint of causing the solid electrolyte layer to exhibit plasticity etc. Examples of such a binding agent include the materials mentioned above as examples of the binding agent for the positive electrode layer. The solid electrolyte layer may contain 5 mass % or less of the binding agent from the standpoint of, for example, preventing excessive agglomeration of the solid electrolyte and enabling formation of a solid electrolyte layer containing a uniformly dispersed solid electrolyte in order to facilitate an increase in output power.

The thickness of the solid electrolyte layer is not particularly limited, and is usually 0.1 μm or more and 1 mm or less. Examples of a method for forming a solid electrolyte layer include a method in which a solid electrolyte layer forming paste containing a solid electrolyte is applied to a support and dried, and a method in which a powder of a solid electrolyte material containing a solid electrolyte is pressure-formed. Examples of the support are similar to the examples of the support mentioned above for the positive electrode layer. When pressure-forming a powder of a solid electrolyte material, a press pressure of about 1 MPa or more and about 2000 MPa or less is usually applied to the powder. The pressing method is not particularly limited, but examples of the pressing method include the methods mentioned above as examples for formation of the positive electrode layer.

The battery includes, as necessary, an outer package that houses a stack obtained by stacking the positive electrode current collector, the positive electrode layer, the electrolyte layer, and the negative electrode layer in this order, a restraining member, etc. The material of the outer package is not particularly limited as long as it is stable against an electrolyte. Examples of the material of the outer package include resins such as polypropylene, polyethylene, and acrylic resin. The restraining member may be any member that can apply a restraining pressure to the stack in the stacking direction, and various restraining members that can be used as restraining members for batteries can be used as the restraining member. An example of the restraining member is a restraining member including plate portions that sandwich the stack from both sides, rod portions that connect the two plate portions, and adjusting portions that are connected to the rod portions and adjust the restraining pressure by a screw structure etc. A desired restraining pressure can be applied to the stack by the adjusting portions. The restraining pressure is not particularly limited, but may be, for example, 0.1 MPa or more, 1 MPa or more, or 5 MPa or more. This is because applying a high restraining pressure is advantageously facilitates satisfactory contact between the layers. The restraining pressure may be, for example, 100 MPa or less, 50 MPa or less, or 20 MPa or less. This is because, when applying a too high restraining pressure, the restraining member is required to have high rigidity, and this may lead to an increase in size of the restraining member.

The battery may include only one stack, or may be a stack of a plurality of the stacks. The battery may be a primary battery or a secondary battery. In particular, the battery may be a secondary battery. A secondary battery can be repeatedly charged and discharged. A secondary battery is useful as, for example, an in-vehicle battery. The battery may be an aqueous battery, a non-aqueous battery, an all-solid-state battery, etc. The battery may be a lithium battery, a lithium-ion battery, etc. An all-solid-state battery may be an all-solid-state lithium secondary battery, an all-solid-state lithium-ion secondary battery, etc. Examples of the shape of the battery include a coin, a laminate, a cylinder, and a rectangle. Applications of the battery are not particularly limited, but include, for example, power supplies for vehicles such as hybrid electric vehicles (HEVs), plug-in hybrid electric vehicles (PHEVs), battery electric vehicles (BEVs), gasoline vehicles, and diesel vehicles. The battery may be used particularly for power supplies for driving hybrid electric vehicles, plug-in hybrid electric vehicles, or battery electric vehicles. The battery in the present disclosure may be used as power sources for moving bodies other than vehicles (e.g., trains, ships, and aircrafts), or may be used as power sources for electric products such as information processing devices.

When the battery of the present disclosure is an all-solid-state battery, the following method may be used to manufacture an all-solid-state battery. For example, a solid electrolyte layer forming paste is first applied to a support and dried to form a solid electrolyte layer. Next, a positive electrode layer forming paste containing a positive electrode active material is applied to a first surface of the solid electrolyte layer and dried to form a positive electrode layer. The support is then removed from the solid electrolyte layer, and a negative electrode layer forming paste is applied to a second surface, namely the other surface, of the solid electrolyte layer and dried to form a negative electrode layer. As necessary, a positive electrode current collector is attached to the opposite surface of the positive electrode layer from the solid electrolyte layer, and a negative electrode current collector is attached to the opposite surface of the negative electrode layer from the solid electrolyte layer to produce an all-solid-state battery.

Production of Adhesive Layer-Coated Aluminum Foil

Vapor-grown carbon fibers (VGCFs) and acetylene black (AB) as an electrically conductive material and an acrylic binder (Aron Tac S1551, made by TOAGOSEI CO., LTD.) as an adhesive were weighted to the following volume ratio: electrically conductive material:adhesive=25 vol %:75 vol %. NMP was added to the weighted electrically conductive material and adhesive to produce an adhesive layer composition. Thereafter, one surface of aluminum foil (positive electrode current collector) was coated with the adhesive layer composition, and the adhesive layer composition was dried at 100° C. for one hour to produce adhesive layer-coated aluminum foil.

### Production of Carbon-Coated Aluminum Foil According to Related Art

VGCFs and AB as an electrically conductive material and PVDF as an adhesive were weighed to the following volume ratio: electrically conductive material:adhesive=25 vol %:75 vol %. NMP was added to the weighted electrically conductive material and adhesive to produce a carbon coating composition. Thereafter, one surface of aluminum foil (positive electrode current collector) was coated with the carbon coating composition, and the carbon coating composition was dried at 100° C. for one hour to produce carbon-coated aluminum foil.

### Example 1

Production of Positive Electrode Layer Forming Paste

LiNi_{0.8}Co_{0.2}Al_{0.2}O₂ (hereinafter referred to as NCA) was used as a positive electrode active material. Positive electrode active material particles (particles whose main phase is LiNi_{0.8}Co_{0.2}Al_{0.2}O₂) were coated with lithium niobate in an air atmosphere using a tumbling fluidized bed coating machine (manufactured by Powrex Corporation), and were fired in an air atmosphere to produce composite active material particles with a lithium niobate coating layer. The composite active material particles, VGCFs and AB as an electrically conductive material, a solid electrolyte, SBR as a binder, and a solvent were weighed and mixed using an ultrasonic homogenizer (UH-50 made by SMT Co., Ltd.) to produce a positive electrode layer forming paste. The electrically conductive material was prepared so that the volume fraction of the electrically conductive material in a positive electrode layer to be obtained would be 3.51 volume % when the total volume of the positive electrode layer was taken as 100 volume %. The spherical carbon AB was prepared so that the mass fraction of the spherical carbon AB relative to the positive electrode active material was 0.3 mass % when the total mass of the positive electrode active material in the positive electrode layer was taken as 100 mass %. The fibrous carbon VGCFs was prepared so that the mass fraction of the fibrous carbon VGCFs relative to the positive electrode active material was 2.34 mass % when the total mass of the positive electrode active material in the positive electrode layer was taken as 100 mass %. The spherical carbon AB was prepared so that the mass fraction of the spherical carbon AB was 11.4 mass % when the total mass of the spherical carbon AB and the fibrous carbon VGCFs in the positive electrode layer was taken as 100 mass %.

Production of Negative Electrode Layer Forming Paste

Predetermined amounts of Li₄Ti₅O₁₂ particles as a negative electrode active material, a carbon material as an electrically conductive material, a binder, and butyl butyrate were added together and mixed for 30 minutes using an ultrasonic homogenizer (UH-50 made by SMT Co., Ltd). Thereafter, a solid electrolyte was added to the resultant slurry, and the mixture was mixed again for 30 minutes using the ultrasonic homogenizer (UH-50 made by SMT Co., Ltd.) to produce a negative electrode layer forming paste.

Production of Solid Electrolyte Layer Forming Paste

A heptane solution containing heptane and 5 mass % of a butadiene rubber binder, and an LiI—LiBr—Li₂S—P₂S₅ glass-ceramic with an average particle size of 2.5 μm as a sulfide solid electrolyte were placed into a polypropylene container and mixed for 30 seconds using the ultrasonic homogenizer (UH-50 made by SMT Co., Ltd.). Thereafter, the container was shaken in a shaker for three minutes to produce a solid electrolyte layer forming paste.

Production of Negative Electrode

A negative electrode current collector was coated with the negative electrode layer forming paste by a blade method using an applicator. After the coating, the negative electrode layer forming paste was dried on a hot plate at 100° C. for 30 minutes to produce a negative electrode having a negative electrode layer on a negative electrode current collector. In all of examples and comparative examples, the basis weight of the negative electrode layer was adjusted so that the charge specific capacity of the negative electrode was one time as large as when the charge specific capacity of the positive electrode was 200 mAh/g.

Production of Solid Electrolyte Layer

Aluminum foil was coated with the solid electrolyte layer forming paste by a blade method, and the solid electrolyte layer forming paste was dried on a hot plate at 100° C. for 30 minutes. Thereafter, roll pressing was performed at 1 ton/cm to produce a negative electrode stack having a solid electrolyte layer on a negative electrode layer.

Production of Positive Electrode

Aluminum foil was coated with the positive electrode layer forming paste by a blade method using an applicator. After the coating, the positive electrode layer forming paste was dried on a hot plate at 100° C. for 30 minutes to produce an aluminum foil-positive electrode layer stack having a positive electrode layer on aluminum foil. The aluminum foil-positive electrode layer stack was placed on the solid electrolyte layer of the negative electrode stack such that the positive electrode layer was in contact with the solid electrolyte layer, and the resultant stack was pressed at 130° C. at 5 ton/cm. Thereafter, the aluminum foil was removed from the aluminum foil-positive electrode layer stack, and the adhesive layer-coated aluminum foil produced in the above section “Production of Adhesive Layer-Coated Aluminum Foil” was placed on the exposed positive electrode layer such that the adhesive layer was in contact with the positive electrode layer. A positive electrode having adhesive layer-coated aluminum foil and a positive electrode layer was thus produced. A power generation element in which a positive electrode, a solid electrolyte layer, and a negative electrode were stacked in this order was thus produced. The power generation element was sealed in a laminate and restrained at 80° C. and 5 MPa for 20 hours to bond the adhesive layer-coated aluminum foil to the positive electrode layer.

Production of All-Solid-State Lithium-Ion Secondary Battery

Subsequently, the power generating element was cooled to 25° C. and adjusted to a restraining pressure of 0.5 MPa to produce an all-solid-state lithium-ion secondary battery of an evaluation cell.

### Examples 2 to 6

A positive electrode and an all-solid-state lithium-ion secondary battery were produced by a method similar to that of Example 1 except that the amount of electrically conductive material shown in Table 1 was used in the above section “Production of Positive Electrode Layer Forming Paste.”

### Comparative Examples 1 to 6

The amount of electrically conductive material shown in Table 1 was used in the above section “Production of Positive Electrode Layer Forming Paste.” In the above section “Production of Positive Electrode,” the aluminum foil was removed from the aluminum foil-positive electrode layer stack, and instead of the adhesive layer-coated aluminum foil, the carbon-coated aluminum foil according to the related art produced in the above section “Production of Carbon-Coated Aluminum Foil According to Related Art” was placed on the exposed positive electrode such that the carbon coating was in contact with the positive electrode layer. A positive electrode having carbon-coated aluminum foil according to the related art and a positive electrode layer was thus produced. A power generation element in which a positive electrode, a solid electrolyte layer, and a negative electrode were stacked in this order was thus produced. The power generation element was sealed in a laminate and restrained at 80° C. and 5 MPa for 20 hours to bond the carbon-coated aluminum foil according to the related art to the positive electrode layer. A positive electrode and an all-solid-state lithium-ion secondary battery were produced by a method that is otherwise similar to that of Example 1.

Electron Conductivity Measurement for Positive Electrode Layer

The electron conductivity of the positive electrode layer was evaluated under the following conditions using the positive electrodes of Examples 1 to 6 and Comparative Examples 1 to 6. Two positive electrodes were removed from the power generation elements produced in the above section “Production of Positive Electrode” before each power generation element was sealed in a laminate. The two positive electrodes were placed on top of each other so as to face each other, and the resultant stack was roll-pressed at 5 ton/cm. The opposing positive electrodes thus pressed together were blanked, and the overall thickness of the blanked positive electrodes was measured. Thereafter, the blanked positive electrodes were sealed in a laminate and restrained at 5 MPa to produce a cell for electronic conductivity evaluation. A current value flowing through the obtained cell when a constant voltage of −0.10 V to +0.10 V was applied thereto was read, and the resistance was calculated by Ohm's law. The electron conductivity of the positive electrode layer was calculated from the calculated resistance and the thickness. The results are shown in Table 1.

TABLE 1

| | | | | | Electrically | |
|---|---|---|---|---|---|---|
| | | | | | Conductive | |
| | | | | | Material/Positive | Electron |
| | Current | AB/NCA | VGCF/NCA | AB/(VGCF + AB) | Electrode Layer | Conductivity |
| | Collector | (mass %) | (mass %) | (mass %) | (volume %) | (mS/cm) |
| Example 1 | Adhesive | 0.3 | 2.34 | 11.4 | 3.51 | 4.03 |
| Example 2 | Layer- | 0.3 | 2.70 | 10.0 | 3.97 | 4.81 |
| Example 3 | Coated Al | 0.3 | 2.94 | 9.3 | 4.27 | 6.17 |
| Example 4 | Foil | 0.3 | 3.18 | 8.6 | 4.57 | 10.13 |
| Example 5 | | 0.3 | 3.30 | 8.3 | 4.72 | 11.83 |
| Example 6 | | 0.3 | 4.00 | 7.0 | 5.59 | 30.39 |
| Comparative | Conventional | 0.3 | 2.34 | 11.4 | 3.51 | 4.03 |
| Example 1 | Carbon- | | | | | |
| Comparative | Coated Al | 0.3 | 2.70 | 10.0 | 3.97 | 4.81 |
| Example 2 | Foil | | | | | |
| Comparative | | 0.3 | 2.94 | 9.3 | 4.27 | 6.17 |
| Example 3 | | | | | | |
| Comparative | | 0.3 | 3.18 | 8.6 | 4.57 | 10.13 |
| Example 4 | | | | | | |
| Comparative | | 0.3 | 3.30 | 8.3 | 4.72 | 11.83 |
| Example 5 | | | | | | |
| Comparative | | 0.3 | 4.00 | 7.0 | 5.59 | 30.39 |
| Example 6 | | | | | | |

Measurement of Foil Contact Resistance

The foil contact resistance of the positive electrode layer with the positive current collector foil was evaluated under the following conditions using the positive electrodes of Examples 1 to 6. One positive electrode was removed from the power generation element produced in the above section “Production of Positive Electrode” before the power generation element was sealed in a laminate. This positive electrode was roll-pressed at 5 ton/cm. The pressed positive electrode was sealed in a laminate and restrained at 80° C. and 5 MPa for 20 hours to bond the adhesive layer-coated aluminum foil to the positive electrode layer. Subsequently, the resultant positive electrode was cooled to 25° C. and adjusted to a restraining pressure of 0.5 MPa to produce an evaluation cell for evaluation of the foil contact resistance. A current value flowing through the obtained evaluation cell for evaluation of the foil contact resistance when a constant voltage of −0.10 V to +0.10 V was applied thereto was read, and the resistance was calculated by Ohm's law. The foil contact resistance of the positive electrode layer with the positive current collector foil was calculated by subtracting the resistance value derived from electron conduction in the positive electrode layer from the calculated resistance value. The results are shown in Table 2. In Comparative Examples 1 to 6, the foil contact resistance of the positive electrode layer with the positive electrode current collector foil was calculated using the positive electrodes of Comparative Examples 1 to 6 under the same conditions as those described above except that the carbon-coated aluminum foil according to the related art produced in the above section “Production of Carbon-Coated Aluminum Foil According to Related Art” instead of the adhesive layer-coated aluminum foil was bonded to the positive electrode layer. The foil contact resistance of each of the examples and comparative examples was calculated as a ratio (%) to the direct current (DC) resistance before endurance of Example 1 with the DC resistance before endurance of Example 1 measured in the section “Measurement of DC Resistance (DC-IR) Before Endurance of Evaluation Cell” described later being taken as 100%. The results are shown in Table 2.

Charging and Discharging of Evaluation Cell

The evaluation cells were charged and discharged under the following conditions using the all-solid lithium-ion secondary batteries of the evaluation cells of Examples 1 to 6 and Comparative Examples 1 to 6. Charging: each cell was charged at a constant current equivalent to 0.3 C. After the cell voltage reached 2.7 V, the cell was charged at a constant voltage, and the constant voltage charging was ended when the charging current reached a value equivalent to 0.01 C. Discharging: each cell was discharged at a constant current equivalent to 0.3 C. After the cell voltage reached 1.5 V, the cell was discharged at a constant voltage, and the constant voltage discharging was ended when the discharging current reached a value equivalent to 0.01 C.

Measurement of DC Resistance (DC-IR) Before Endurance of Evaluation Cell

The DC resistance (DC-IR) before endurance was measured under the following conditions using the all-solid-state lithium-ion secondary batteries of the evaluation cells of Examples 1 to 6 and Comparative Examples 1 to 6.

Each cell was charged at a constant current equivalent to 60 C, and the DC resistance before endurance was calculated by dividing the difference between the voltage before charging and the voltage after charging for 10 seconds by the current corresponding to 60 C. The DC resistance before endurance of each of the examples and comparative examples was calculated as a ratio (%) to the DC resistance before endurance of Example 1 with the DC resistance before endurance of Example 1 being taken as 100%. The results are shown in Table 2.

Measurement of Total Resistance Before Endurance of Evaluation Cell

For each of the all-solid-state lithium-ion secondary batteries of the evaluation cells of Examples 1 to 6 and Comparative Examples 1 to 6, the total resistance before endurance of the evaluation cell was calculated by adding the foil contact resistance and the DC resistance before endurance calculated above. The results are shown in Table 2.

Measurement of DC Resistance (DC-IR) after Endurance of Evaluation Cell

The DC resistance (DC-IR) after endurance was measured under the following conditions using the all-solid-state lithium-ion secondary batteries of the evaluation cells of Examples 1 to 6 and Comparative Examples 1 to 6. Each cell was charged and discharged a predetermined number of times under the same conditions as those in the above section “Charging and Discharging of Evaluation Cell,” and was then charged at a constant current equivalent to 60 C. The DC resistance after endurance was calculated by dividing the difference between the voltage before charging and the voltage after charging for 10 seconds by the current corresponding to 60 C. The DC resistance after endurance of each of the examples and comparative examples was calculated as a ratio (%) to the DC resistance after endurance of Example 1 with the DC resistance after endurance of Example 1 being taken as 100%. The results are shown in Table 2.

Measurement of Total Resistance after Endurance of Evaluation Cell

For each of the all-solid-state lithium-ion secondary batteries of the evaluation cells of Examples 1 to 6 and Comparative Examples 1 to 6, the total resistance after endurance of the evaluation cell was calculated by adding the foil contact resistance and the DC resistance after endurance calculated above. The results are shown in Table 2.

Measurement of Rate of Increase in DC Resistance (DC-IR) after Endurance of Evaluation Cell

For each of the all-solid-state lithium-ion secondary batteries of the evaluation cells of Examples 1 to 6 and Comparative Examples 1 to 6, the rate of increase DC resistance after endurance of the evaluation cell was calculated by dividing the DC resistance after endurance of each of the examples and comparative examples calculated above by the DC resistance before endurance of each of the examples and comparative examples calculated above. The results are shown in Table 2.

TABLE 2

| | | Total | Total | | | |
|---|---|---|---|---|---|---|
| | Foil | Resistance | Resistance | DC-IR | DC-IR | |
| | Contact | Before | After | Before | After | Rate of |
| | Resistance | Endurance | Endurance | Endurance | Endurance | Increase in |
| | (%) | (%) | (%) | (%) | (%) | DC-IR (−) |
| Example 1 | 14.3 | 114.3 | 155.8 | 100.0 | 141.5 | 1.41 |
| Example 2 | 5.5 | 82.7 | 99.5 | 77.2 | 94.0 | 1.22 |
| Example 3 | 4.1 | 77.9 | 91.2 | 73.8 | 87.1 | 1.18 |
| Example 4 | 3.3 | 73.1 | 86.9 | 69.8 | 83.6 | 1.20 |
| Example 5 | 2.7 | 70.3 | 86.7 | 67.6 | 84.0 | 1.24 |
| Example 6 | 1.7 | 85.3 | 127.0 | 83.6 | 125.3 | 1.50 |
| Comparative | 43.8 | 143.8 | 185.3 | 100.0 | 141.5 | 1.41 |
| Example 1 | | | | | | |
| Comparative | 25.9 | 103.1 | 119.9 | 77.2 | 94.0 | 1.22 |
| Example 2 | | | | | | |
| Comparative | 15.5 | 89.3 | 102.6 | 73.8 | 87.1 | 1.18 |
| Example 3 | | | | | | |
| Comparative | 10.4 | 80.2 | 94.1 | 69.8 | 83.6 | 1.20 |
| Example 4 | | | | | | |
| Comparative | 8.6 | 76.2 | 92.7 | 67.6 | 84.0 | 1.24 |
| Example 5 | | | | | | |
| Comparative | 2.9 | 86.5 | 128.2 | 83.6 | 125.3 | 1.50 |
| Example 6 | | | | | | |

Evaluation Results

The results in Tables 1 and 2 demonstrate that, in Examples 1 to 6, the foil contact resistance of the positive electrode layer with the positive electrode current collector foil can be significantly reduced by the use of the adhesive layer-coated aluminum foil as compared to the use of the carbon-coated aluminum film according to the related art in Comparative Examples 1 to 6. The results in Table 2 also show that, the total resistance before endurance and the total resistance after endurance in Examples 1 to 6 are lower than those in Comparative Examples 1 to 6 by the amount by which the foil contact resistance of the positive electrode layer with the positive electrode current collector foil is reduced. The results in Tables 1 and 2 also show that the rate of increase in DC resistance (DC-IR) after endurance in Example 6 and Comparative Example 6 is larger than that in Examples 1 to 5 and Comparative Examples 1 to 5. The above results indicate that the electron conductivity of the positive electrode layer can be improved by increasing the amount of electrically conductive material in the positive electrode layer, but the durability of the battery would be reduced if the amount of electrically conductive material in the positive electrode layer is increased too much. Therefore, by setting the amount of electrically conductive material in the positive electrode layer within a predetermined range, an increase in DC resistance after endurance of the battery can be reduced, and the durability of the battery can be improved. Based on the above, according to the present disclosure, the use of the adhesive layer-coated aluminum foil reduces the foil contact resistance of the positive electrode layer with the positive electrode current collector foil, and the amount of electrically conductive material in the positive electrode layer can be reduced by an amount corresponding to the reduction in foil contact resistance. A battery with lower resistance and higher durability can thus be implemented.

What is claimed is:

1. A positive electrode comprising:
a positive electrode current collector;
an adhesive layer; and
a positive electrode layer, wherein:
the positive electrode current collector, the adhesive layer, and the positive electrode layer are stacked in this order; and
the adhesive layer contains spherical carbon and fibrous carbon as an electrically conductive material, and contains an acrylic binder as an adhesive.

2. The positive electrode according to claim 1, wherein:
the positive electrode layer contains a positive electrode active material;
the positive electrode active material is a lithium-transition metal composite oxide represented by LiNiₓM₁₋ₓO₂; and
in the lithium-transition metal composite oxide, x satisfies 0.5≤x<1, and M represents at least one element selected from the group consisting of cobalt (Co), manganese (Mn), and aluminum (Al).

3. The positive electrode according to claim 2, wherein:
the positive electrode layer contains the spherical carbon and the fibrous carbon as the electrically conductive material; and
a volume fraction of the electrically conductive material in the positive electrode layer is 3 volume % to 6 volume % when a total volume of the positive electrode layer is taken as 100 volume %.

4. The positive electrode according to claim 2, wherein a mass fraction of the spherical carbon is 7 mass % to 12 mass % when a total mass of the spherical carbon and the fibrous carbon in the positive electrode layer is taken as 100 mass %.

5. The positive electrode according to claim 1, wherein the spherical carbon is acetylene black.

6. The positive electrode according to claim 1, wherein a volume fraction of the acrylic binder in the adhesive layer is 50 volume % to 80 volume % when a total volume of the adhesive layer is taken as 100 volume %.
